(19) United States
(12) Patent Application Publication
(10) Pub. No.: US 2023/0222301 A1
(43) Pub. Date: Jul. 13, 2023

(54) SYSTEM WITH READER, TRANSPONDER AND SENSORS AND OPERATING METHOD

(71) Applicant: STMicroelectronics (Rousset) SAS, Rousset (FR)

(72) Inventor: Jose MANGIONE, Mougins (FR)

(73) Assignee: STMicroelectronics (Rousset) SAS, Rousset (FR)

(21) Appl. No.: 18/093,423

(22) Filed: Jan. 5, 2023

(30) Foreign Application Priority Data
Jan. 7, 2022 (FR) 2200105

(51) Int. Cl. G06K 7/10; G06K 19/07

(52) U.S. Cl. CPC G06K 7/10297; G06K 19/0702

(57) ABSTRACT

A contactless transponder includes an autonomous power supply and a non-volatile memory device. In a first mode of operation, an apparatus external to the transponder transmits to the transponder, according to a contactless communication protocol, module command information associated with a module external to the transponder and module data information relating to data to be written to or to be read from the module. The transponder stores the module command information and module data information in a first area of the non-volatile memory device. In response to an activation signal, the transponder autonomously communicates, according to a first communication protocol, with the module by using the module command information and module data information.

### PRIORITY CLAIM

This application claims the priority benefit of French Application for Patent No. 2200105, filed on Jan. 7, 2022, the content of which is hereby incorporated by reference in its entirety to the maximum extent allowable by law.

### TECHNICAL FIELD

Implementations and embodiments relate to connected objects (Internet of Things—IOT), particularly sensors, in particular those requiring a periodic collection of their measured data, for example those used in the medical field to periodically measure the temperature of a medical product, as well as contactless transponders, particularly Near Field Communication (NFC) transponders, for example tags and in particular the use of such transponders for a dialogue with at least one sensor coupled to the transponder by a wired connection, for example an I²C or SPI bus.

### BACKGROUND

Near Field Communication (NFC) is a wireless connectivity technology that makes it possible to communicate over a short distance, for example 10 cm, between electronic devices, such as, for example, contactless integrated circuit cards or tags, and readers.

NFC technology is particularly adapted to connect any type of user device and make fast and easy communications possible.

A contactless transponder is a transponder capable of exchanging information via an antenna with a contactless reader, according to a contactless communication protocol.

An NFC transponder, which is a contactless transponder, is a transponder compatible with NFC technology.

NFC technology is an open technology platform standardized in the standard ISO/IEC 18092 and ISO/IEC 21481 but incorporates many already existing standards such as for example the type A and type B protocols defined in the standard ISO-14443 that may be communication protocols that can be used in NFC technology.

Contactless technology may also be used in RFID (Radio Frequency IDentification) transponders compatible with the standards ISO 15693 and ISO 18000-3.

During a transmission of information between a reader and a transponder, the reader generates a magnetic field through use of its antenna that is generally in the standards conventionally used, a sine wave (the carrier) at 13.56 MHz.

In order to transmit information from the reader to the transponder, the reader uses an amplitude modulation of said carrier.

The transponder for its part includes a circuit configured to demodulate the received carrier in order to obtain the data transmitted from the reader.

For a transmission of information from the transponder to the reader, the reader generates the magnetic field (the carrier) without modulation. The antenna of the transponder then modulates the field generated by the reader, depending on the information to be transmitted. The frequency of this modulation corresponds to a sub-carrier of said carrier. The frequency of this sub-carrier depends on the communication protocol used and may be for example equal to 848 kHz.

This modulation is performed by modifying the load connected to the terminals of the antenna of the transponder.

Two modes of operation are then possible, a passive mode or an active mode.

In the passive mode, the transponder back-modulates the wave from the reader in order to transmit information and does not integrate, for the transmission of information, transmission means strictly speaking, or transmitter, capable for example of generating its own magnetic field during the transmission. Such a transponder devoid of transmitter is called passive transponder, as opposed to an active transponder that includes a transmitter.

Generally, a passive transponder is devoid of power supply because it uses the electromagnetic wave from the reader to power its integrated circuit.

In some applications the passive transponder may incorporate a power supply, for example a battery.

In the active mode of operation, the reader and the transponder known as active both generate an electromagnetic field. Generally, this mode of operation is used when the active transponder is provided with a specific power source, for example a battery.

Each of the NFC devices (reader and transponder) transmits the data by using a modulation scheme.

Here again, the modulation results in a load modification and this is then referred to as an active load modulation communication.

Compared to a passive communication mode, greater operating distances are obtained that may reach up to 20 cm depending on the protocol used. By increasing the size of the antenna of the reader, and/or the sensitivity of the reader, it is then possible to increase the distance up to distances that may reach several tens of cm, for example 60 cm.

Moreover, the use of an active load modulation makes it possible to use very small antennas.

Currently, there is a need to offer a solution that consumes less energy making it possible at a lower cost to, particularly, configure a sensor, in particular a sensor requiring a periodic collection of its measured data, and of being able to subsequently store and retrieve the data acquired, for example periodically, by the sensor.

According to a first solution of the prior art, the transponder simply acts as a tunnel, that is to say that it receives at a given instant a command from a contactless reader, transforms it into an I²C command for example, and sends it to the sensor connected to the transponder. In other words, the reader has total control of the operations performed by the sensor. This implies that the reader is permanently present so that the sensor operates which is impossible for sensors implementing periodic measurements for applications or the reader may not be permanently within the vicinity of the transponder.

According to a second solution of the prior art, the transponder cooperates with a microcontroller that cooperates with the sensor without the presence of the reader. But this microcontroller, which is the master on the I²C bus, is a distinct component of the transponder having its own memory for storing its firmware. On the one hand such a solution is not optimized in terms of cost and of consumption and on the other hand it is difficult to change the firmware of the microcontroller throughout the life of the product, which is a problem in particular for use with very simple sensors.

### SUMMARY

Embodiments herein apply just as well to passive transponders as to active transponders.

According to one aspect a system comprises: a contactless transponder including a non-volatile memory device, for example an EEPROM memory; an apparatus external to the transponder, for example a smartphone including a contactless reader; an autonomous power supply, for example a battery, configured to power the transponder; and at least one module external to the transponder, for example a sensor, and coupled to the transponder, for example by a “wired” connection, such as a bus of the I²C or SPI type.

The system has a first mode of operation wherein the apparatus is configured to transmit to the transponder, according to a contactless communication protocol, module command information associated with said at least one module, and module data information relating to data to be written or to be read in said module, for example information for creating I²C or SPI read or write commands, containing particularly an identifier of the module, a number of bytes to be read or to be written, the data strictly speaking to be written, control information, etc. I the first mode of operation the transponder is configured to store this module command information and this module data information in a first area of the non-volatile memory device and to, in response to an activation signal, communicate autonomously according to a first communication protocol, for example a protocol of the I²C type with said at least one module by using this module command information and this module data information.

According to one embodiment, the apparatus is configured to deliver to the transponder data to be written in said at least one module by using the second contactless communication protocol, the transponder is configured to store this data in a first sub-area of the first memory area of the non-volatile memory device and the module command information includes command information to write this data in said at least one module.

According to one embodiment, the module command information includes command information to read data in said at least one module, and the transponder is configured to store the read data in a second sub-area of the first area of the non-volatile memory device, and to communicate this read data to the external apparatus by using the second contactless communication protocol.

Said at least one module is, for example, coupled to the transponder by a bus supporting the first communication protocol which is, for example, a serial communication protocol.

The transponder may be configured to communicate with a plurality of modules that are coupled to it and each item of module command information associated with a module includes an identifier of this module, for example the address of the module on the I²C bus.

According to one embodiment, the transponder comprises: a first interface configured to communicate with said at least one module according to the first communication protocol; and a second interface configured to communicate with the external apparatus according to the second contactless communication protocol. The apparatus is configured to deliver to the second interface initial commands in accordance with the second communication protocol, for example commands in accordance with a NFC protocol and containing, for example in the payload field said module command information and said module data information. The second interface of the transponder is configured, for example by way of a NFC controller, to extract said module command information and said module data information from the initial commands and deliver it to the memory device in view of its storage. The transponder comprises a processing circuit, for example a state machine, configured to, autonomously and in response to the activation signal, extract said module command information and said module data information from the memory device and form for each module, a module command and deliver it to the first interface, the first interface being configured, for example by means of an I²C controller, to elaborate from the module command, a final module command in accordance with the first communication protocol, for example the I²C protocol, and to deliver it to said module.

The activation signal is advantageously delivered to the transponder by the apparatus.

Thus, in a general manner, according to this aspect, the non-volatile memory of the transponder is used to store commands that the transponder will be able to execute autonomously by being powered by its own battery, so that they are transmitted to the module(s) through a wired interface, for example an I²C or SPI interface, according to a format compatible with the serial protocol used.

In response to the activation signal, for example a specific command emitted by the apparatus, for example the telephone equipped with a NFC module, the state machine of the transponder autonomously executes the firmware formed by the commands stored in the non-volatile memory and transforms them into data read or write commands in the sensor or sensors.

The procedure with a sensor may be divided into a plurality of phases (programming and/or modification of the programming of the state machine simply and at any time by the sending of commands by the reader, triggering of the state machine, extraction of data from the non-volatile memory, collection of data coming from the sensor or sensors, storage of collected data in the non-volatile memory) that may be optimized depending on the applications.

Finally, the apparatus (or reader) may subsequently retrieve the collected data at any time.

This clearly distinguishes from solutions of the prior art noted above that also provide for a dialogue between a transponder and a sensor.

Similarly, once the state machine of the transponder has been triggered, the transponder operates autonomously, without the presence of the reader being necessary.

According to another embodiment of the system according to this aspect, the system may have a second mode of operation wherein the apparatus and the transponder are configured to make a direct communication possible between the apparatus and said at least one module via a direct communication between the first interface and the second interface of the transponder.

In other words, in this second mode of operation, the transponder behaves like a single passage between the reader and the sensor.

The two modes of operation may be selected, for example, by a selection signal emitted by the apparatus.

The transponder, with these two possible modes of operation, then becomes compatible with applications wherein it is preferable to opt for the second mode of operation.

The power supply of the system may be rechargeable and the transponder may then include an energy harvesting circuit that can be activated by the apparatus and configured to recharge the rechargeable power supply.

According to one embodiment, the system may comprise an object, for example of the connected object type, incorporating the transponder, the autonomous power supply, and optionally at least one module.

According to another aspect, there is proposed a contactless transponder belonging to the system such as defined above.

According to another aspect, there is proposed a method of communication between a contactless transponder, and apparatus external to the transponder and at least one module external to the transponder and coupled to the transponder, comprising a first mode of operation wherein the apparatus transmits to the transponder, according to a contactless communication protocol, module command information associated with said at least one module and module data information relating to data to be written or to be read in said module. The transponder stores this module command information and this module data information in a first area of a non-volatile memory device and in response to an activation signal, and communicates autonomously according to a first communication protocol with said at least one module by using this module command information and this module data information.

According to one implementation, the apparatus delivers to the transponder data to be written in said at least one module by using the second contactless communication protocol, the transponder stores this data in a first sub-area of the first memory area of the non-volatile memory device and the module command information includes command information to write this data in said at least one module.

According to one implementation, the module command information includes command information to read data in said at least one module, and the transponder stores the read data in a second sub-area of the first area of the non-volatile memory device, and communicates this read data to the external apparatus by using the second contactless communication protocol.

According to one implementation, said at least one module is coupled to the transponder by a bus supporting the first communication protocol that is a serial communication protocol.

According to one implementation, the transponder communicates with a plurality of modules that are coupled to it and each item of module command information associated with a module includes an identifier of this module.

The method may have a second mode of operation wherein the apparatus communicates directly with said at least one module by using the transponder as gateway for transferring commands emitted by the apparatus and intended for said at least one module and as gateway for transferring read data in said at least one module and intended for the apparatus.

The apparatus may deliver the activation signal to the transponder.

### BRIEF DESCRIPTION OF THE DRAWINGS

Other advantages and features of the invention will become apparent upon examination of the detailed description of non-limiting implementations and embodiments, and of the appended drawings, wherein:

FIG. 1 illustrates a system comprising a contactless transponder, or tag, including a non-volatile memory device;

FIG. 2 shows module command information including a set of commands;

FIG. 3 illustrates the format of an RF command;

FIG. 4 illustrates the format of the RF command which is a read command;

FIG. 5 illustrates the format of an RF response;

FIGS. 6 to 9 illustrate a first mode of operation of the system;

FIG. 7A illustrates the format of an RF command;

FIGS. 10 to 12 illustrate operation of a processing circuit, where FIG. 10 shows a memory pointer and FIGS. 11 to 12 show flow diagrams for operations;

FIG. 13 shows a timing diagram for data communication on an I²C bus;

FIGS. 14 to 15 show communications between master and slave;

FIG. 16 is a block diagram of an interface;

FIG. 17 illustrates a second mode of operation for the system wherein the apparatus and the transponder are configured to make a direct communication possible between the apparatus and at least one module; and

FIG. 18 illustrates a mode where the power supply ALM may be rechargeable and the transponder may then include an energy harvesting circuit activated by the apparatus and configured to recharge the rechargeable power supply.

### DETAILED DESCRIPTION

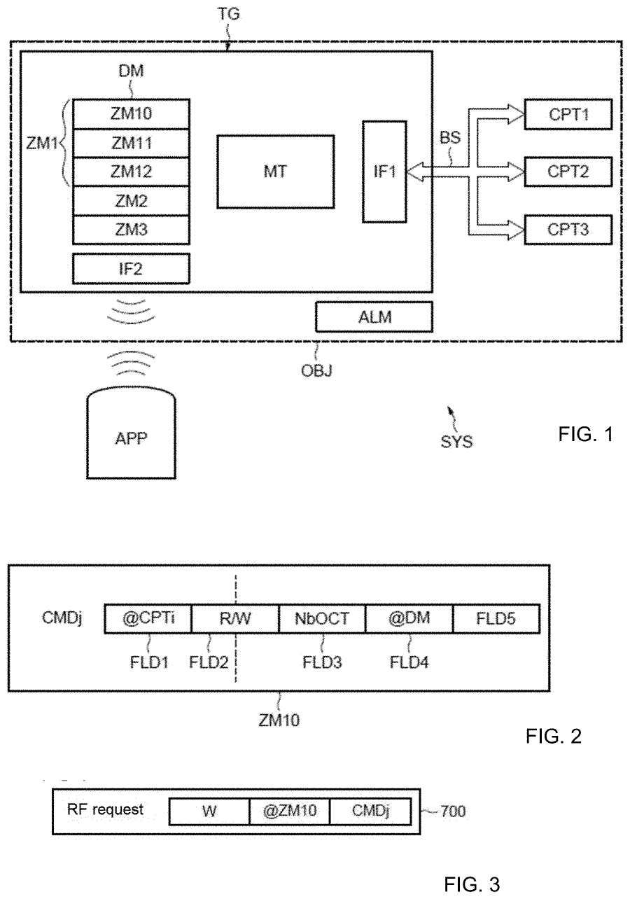

As illustrated in FIG. 1, a system SYS comprises a contactless transponder, or tag TG, including a non-volatile memory device DM, for example an EEPROM memory.

The system also comprises an autonomous power supply ALM, for example a battery, configured to power the transponder.

This power supply ALM may be integrated within the transponder, but generally it is located outside of the transponder TG.

The transponder TG and the power supply ALM are here incorporated into an object OBJ, for example a connected object.

The system SYS also comprises an apparatus APP external to the transponder TG.

This apparatus may be a contactless reader known per se or a mobile phone of the smartphone type emulated in reader mode, also known per se.

The system also comprises at least one module CPTi, external to the transponder TG and coupled to the transponder.

The module may be a sensor, for example but not limited to a temperature sensor.

The sensor or sensors may be incorporated into the object OBJ or located, for one at least of them, outside of the object.

In the example described here, the system SYS comprises a plurality of sensors, for example three sensors CPT1-CPT3.

These sensors are here coupled to the transponder TG by a serial bus BS and via a first interface IF1, here a serial interface, of conventional structure and known per se and including in particular a serial controller.

This bus is, for example, here a bus supporting the I²C protocol well known by the person skilled in the art. It may also be for example a bus supporting the SPI protocol or the I³C protocol, also well known by the person skilled in the art.

As will be seen in more detail below, the system SYS has a first mode of operation wherein the apparatus APP is configured to transmit to the transponder TG according to a contactless communication protocol, for example a NFC protocol with a radio frequency (RF) of 13.56 MHz, and via a second contactless interface IF2, of conventional structure and known per se and including in particular a NFC controller, module command information associated with at least one module, or with a plurality of modules, and module data information relating to data to be written or to be read in the module or modules concerned.

In this first mode of operation, the transponder TG is configured to store this module command information and this module data information in a first area ZM1 of the non-volatile memory device DM.

More specifically, the first memory area ZM1, includes a sub-area ZM10 intended to store the module command information.

For example, this module command information includes a set of commands CMDj (FIG. 2), forming a firmware to be executed.

Each command CMDj includes, for example: a field FLD1 containing the address @CPTi of the module or sensor CPTi concerned by this command; a field FLD2 containing a bit R/W specifying whether the command is a write command or a read command; a field FLD3 containing an indication NbOCT indicating the number of bytes to read from or to write to the sensor concerned; a field FLD4 containing an address @DM of data to read from or to write to the memory DM; and one or more other fields FLDS that may contain other indications, such as, for example, a number of execution iterations to be performed for the command CMDi, a duration, etc.

When the apparatus APP delivers to the transponder data to be written to a module or modules CPTi by using the second contactless communication protocol, the transponder TG is configured to store this data in a first sub-area ZM11 of the first memory area ZM1 of the non-volatile memory device DM and the module command information then includes command information to write this data in the module or modules concerned.

When the module command information includes command information to read data from one or more modules, and the transponder TG is configured to store the read data in the module or modules concerned in a second sub-area ZM12 of the first area ZM1 of the non-volatile memory device, and to communicate this read data to the external apparatus APP by using the second contactless communication protocol.

The memory device DM also includes a second memory area ZM2 intended to store other data, for example other NFC data relating to other applications.

The memory device DM also includes a third memory area ZM3 intended to store configuration data of the transponder.

The commands CMDj are, for example, transmitted in the payload of an RF command 700 (FIG. 3) sent by the apparatus APP.

The RF command 700 has a conventional structure, compatible with the RF protocol used. This command 700 indicates that this concerns a write command (W) and the payload of the command also includes the address @ZM10 to which the command CMDj must be written in the sub-area ZM10 of the non-volatile memory DM.

The NFC controller of the contactless interface IF2, extracts the command CMDj from the RF command 700 and delivers it to the memory device DM in view of its storage at the address @ZM10 in the memory sub-area ZM10.

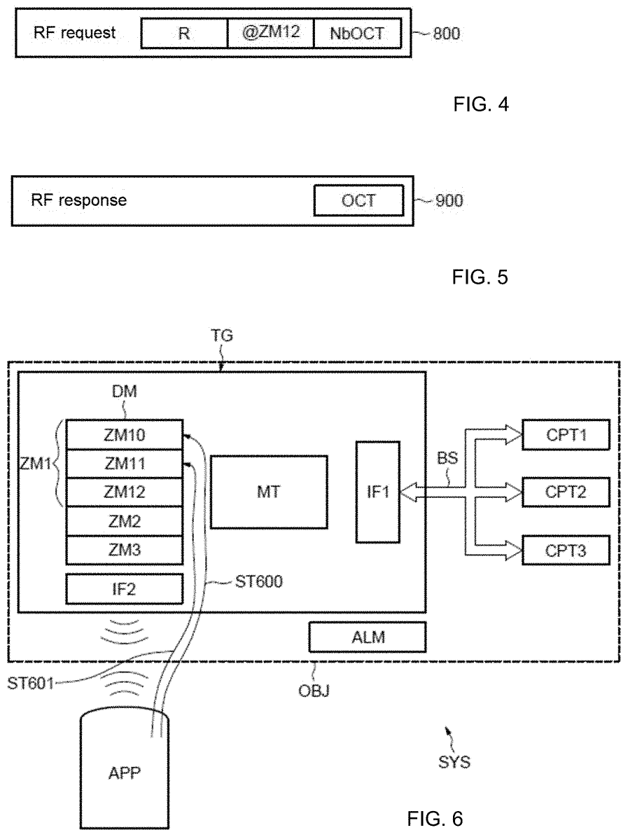

When the apparatus wants to retrieve in the sub-area ZM12 data that was transmitted by one or more sensors, it sends an RF command 800 (FIG. 4) that is a read command (R) and that includes, for example, in its payload the address @ZM12 of the first byte to read as well as the number of bytes NbOCT to read.

The NFC controller of the contactless interface IF2, extracts this payload from the RF command 800 and delivers to the memory device DM the corresponding read command.

The bytes OCT are then read in the memory sub-area ZM12 and the NFC controller elaborates an RF response 900 (FIG. 5) of conventional structure and containing the read bytes OCT in the payload field of the RF response 900.

This RF response 900 may be transmitted to the apparatus APP.

Reference is now made more particularly to FIGS. 6 to 9 to describe the first mode of operation of the system SYS.

In FIG. 6, the apparatus APP transmits to the transponder, according to the contactless communication protocol of the NFC type and via the second interface IF2, the commands CMDj in view of their storage in the memory sub-area ZM10 (step ST600).

If applicable, the apparatus APP also transmits the data to be written to the sensor or sensors CPTi concerned (step ST 601) in view of their storage in the first memory sub-area ZM11.

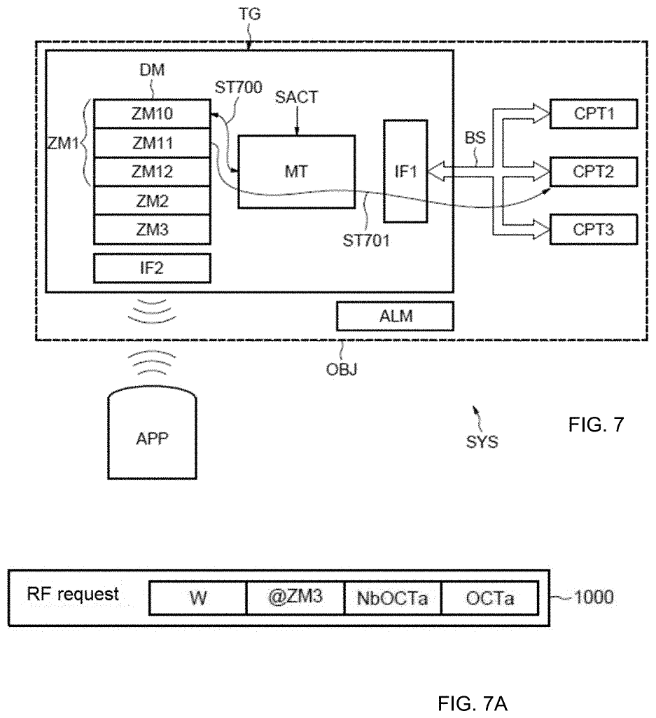

In response to an activation signal SACT (FIG. 7) the processing circuit MT of the transponder TG, whose configuration and operation will be described in more detail below on an example of structure, automatically and autonomously executes (step ST700) the firmware including the commands CMDj stored in the memory sub-area ZM10.

By way of non-limiting example, the activation signal SACT may be transmitted by the apparatus within an RF command of the type of the RF command 700 of FIG. 3.

An example of such a RF command 1000 is illustrated in FIG. 7A.

As indicated above, the third memory area ZM3 contains configuration and status information of the transponder TG.

This RF command 1000 is a command to write to the address @ZM3 in the third memory area ZM3, which corresponds to a so-called activation register, configuration bytes OCTa in a number NbOCTa.

When this RF command 1000 is sent, the activation signal SACT is emitted.

If certain commands CMDj are commands to write data to one or more sensors, the processing circuit extracts this data from the first memory sub-area ZM11 and delivers it to the sensor(s) concerned via the first interface IF1, as will be explained in more detail below.

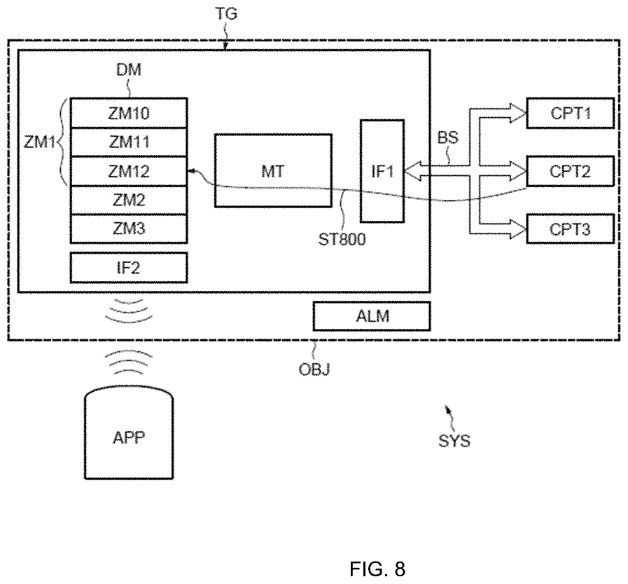

If certain commands CMDj are commands to read data from one or more sensors, the processing circuit receives this data from the sensor or sensors concerned via the first interface IF1, as will be explained in more detail below, and stores it in the second memory sub-area ZM12 (step ST800, FIG. 8).

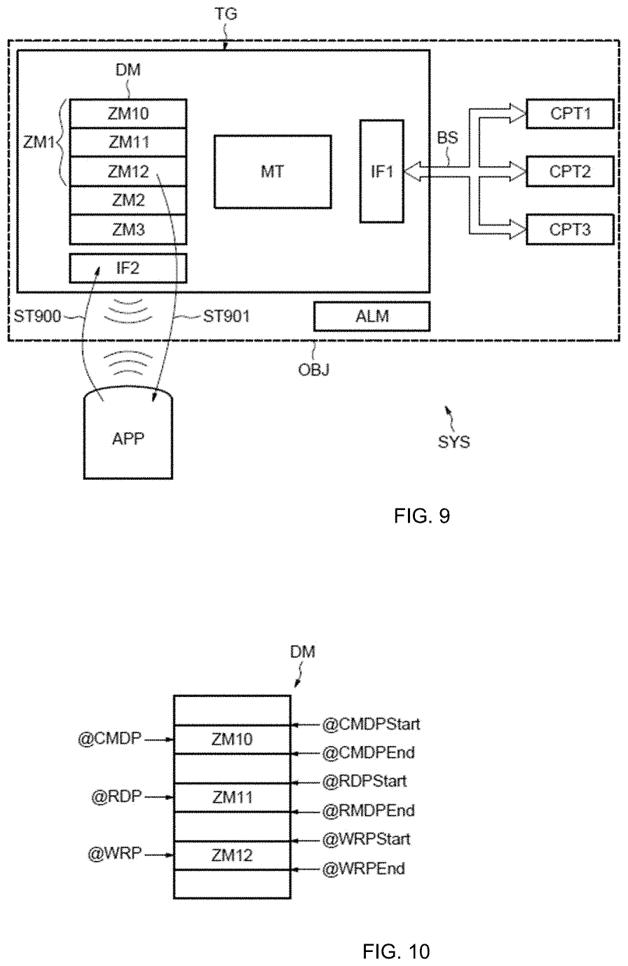

Then as indicated above, when the apparatus APP wants to retrieve the data stored in the memory sub-area ZM12 (which it may do at any time) it emits (step ST900, FIG. 9) an RF request 800 (FIG. 4) and receives (step ST901) the RF response 900 (FIG. 5).

Reference is now made more particularly to FIGS. 10 to 12 to illustrate an example of operation of the processing circuit MT.

These processing circuit comprises a state machine or automaton, formed for example by logic circuits.

The processing circuit MT uses here: a pointer CMDP pointing on the sub-area ZM10 at the current address @CMDP (FIG. 10); a read pointer RDP pointing on the sub-area ZM11 at the current address @RDP; and a write pointer WRP pointing on the sub-area ZM12 at the current address @WRP.

As illustrated in FIG. 10, the pointer CDMP points between the addresses @CDMP Start and @CDMPEnd of the memory DM thus delimiting the range of addresses of the sub-area ZM10.

The pointer RDP points between the addresses @RDPStart and @RDPEnd of the memory DM thus delimiting the range of addresses of the sub-area ZM11.

The pointer WRP points between the addresses @WRPStart and @WRPEnd of the memory DM thus delimiting the range of addresses of the sub-area ZM12.

In a general manner, in response to the activation signal SACT, the state machine MT of the transponder autonomously executes the firmware formed by the commands CMDj stored in the non-volatile memory and transforms them into commands (known as module commands CMDM) for reading and writing data in the sensor or sensors.

These module commands CMDM are delivered to the serial interface IF1 that transforms them into final module commands compatible with the serial protocol used, here the I²C protocol.

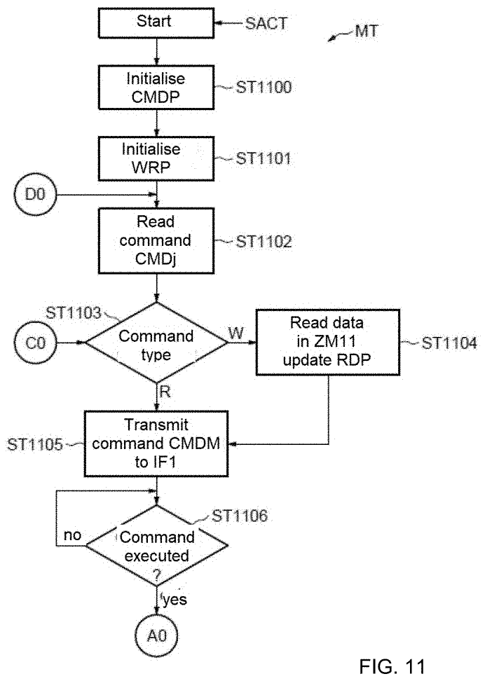

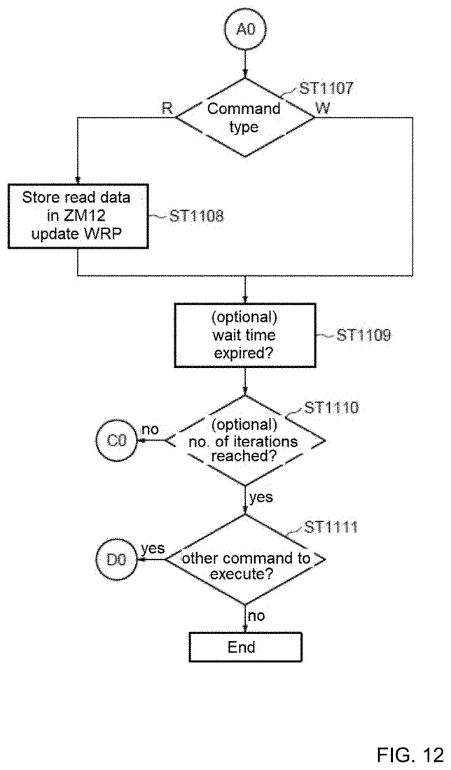

Thus, more specifically, and as illustrated in FIGS. 11 and 12, in response to the activation signal SACT, the processing circuit MT initializes the pointers CMDP and WRP (steps ST100 and ST1101).

Then, in step ST1102, the current command CMDj pointed by the pointer CMDP is read.

If, in step ST1103, the command CMDj is a command to write (W) data to one or more sensors, then the processing circuit MT reads (step ST1104) the data to be written in the memory sub-area ZM11 at the addresses designated by the pointer RDP then updates this pointer.

The next step is step ST1105 that is reached directly if in step ST1103, the command CMDj is a command to read (R) data in one or more sensors.

In step ST1105, the module command CMDM is elaborated and transmitted to the interface IF1.

This module command CMDM particularly includes the address of the sensor concerned on the bus BS, the R/W (read/write) direction, the number of bytes to read or to write.

But this command CMDM does not include the possible check bits specific to the serial protocol used on the bus BS.

These check bits are read by the serial controller of the interface IF1 to form the final module command.

In step ST1106, it is checked whether the command is executed.

If such is the case, the process moves to step ST1107.

If in this step the command executed was a read command (R), then the processing circuit MT performs step ST1108 to store the read data coming from the sensor or sensors concerned in the sub-area ZM12 at the addresses designated by the pointer WRP, then updates the pointer WRP.

Then, in the case where the optional steps ST1109 and ST1110 are not implemented, the process moves to step ST1111.

If, in step ST1107, the command executed was a write command (W), then the processing circuit MT moves directly to step ST1111 in the case where the optional steps ST1109 and ST1110 are not implemented.

In step ST1111, if all the commands CMDj have been executed, the processing circuit MT terminates operations.

In the opposite case, the process moves back to the point DO of the flow chart for the execution of the following command CDMj.

In some applications, a wait time may be necessary after the execution of a command CMDj. This may be indicated in the field FLD5 (FIG. 2) of the command CMDj.

In this case, the processing circuit MT remains in step ST1109 so long as this wait time is not expired. Of course, in this case a counter clocked by a clock signal may be incorporated into the processing circuit MT.

It may sometimes be required that the execution of a command CMDj is reiterated during a chosen number of iterations. This number may here again be indicated in the field FLD5 of the command.

And so long as the number of iterations is not reached, the process moves back to the point C0 of the flow chart.

An example of structure of the serial interface will now be described in more detail, adapted to the I²C serial protocol.

The I²C protocol is well known by the person skilled in the art and may be found in the I²C specification. A few features of the I²C are reiterated.

The I²C uses two wires: serial data (SDA) and serial clock (SCL).

All I²C master and slave devices are connected only with these two wires.

A device operating as master generates a bus clock and initiates the communication on the bus, the other devices are slaves and respond to commands on the bus.

In order to be able to communicate with a specific device, each slave device must have an address that is unique on the bus.

The I²C master device does not need an address because no other device (slave) sends commands to the master.

The two SCL and SDA signals are bidirectional.

At each clock pulse, a data bit is transferred. The SDA signal can only change when the SCL signal is low. When the clock is high, the data is in principle stable.

Each I²C command initiated by the master device starts by a START condition and finishes by a STOP condition. For these two conditions, SCL must be high. An SDA high-low transition is considered as a START condition and a low-high transition is considered as a STOP condition.

After the START condition, the bus is considered as being busy. After the START condition, the master may generate a repeated START condition. This is equivalent to a normal START condition and is generally followed by the slave I²C address.

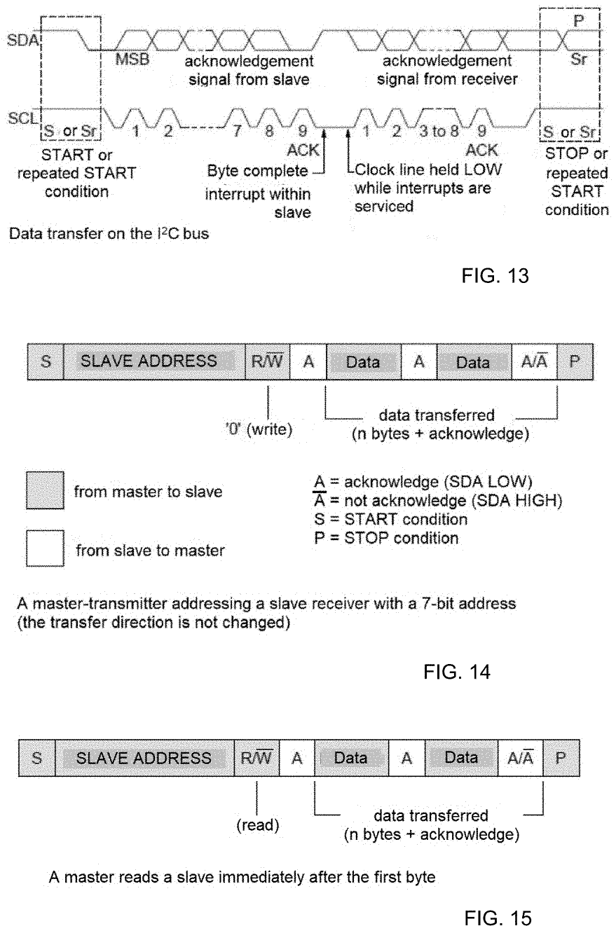

FIGS. 13, 14 and 15 (extracted from the I²C specification version 6.0, 4 April 2014, incorporated by reference) illustrate the features of the I²C protocol.

As illustrated in FIG. 13, the data present on the I²C bus are transferred by 8-bit packets (bytes). There is no limitation of the number of bytes, however each byte must be followed by an acknowledge bit ACK coming from a slave device. This bit ACK indicates whether the slave device is ready to go to the next byte. For all the data bits and the acknowledge bit ACK, the master must generate clock pulses. If the slave device does not acknowledge the transfer, this means that there is no more data or that the device is not yet ready for the transfer. The master device must generate either a STOP condition, or a repeated START condition.

The data is transmitted with the most significant bit (MSB) first. If a slave cannot receive or transmit another complete byte of data until it has executed another function, for example servicing an internal interrupt, it may hold the clock line SCL low to force the master into a wait state. The data transfer then continues when the slave is ready for another byte of data and releases the clock line SCL.

As shown in FIGS. 14 and 15, each slave device on the bus must have a unique 7-bit address.

The communication starts with the START condition, followed by the 7-bit slave address and the data direction bit R/W.

If this bit R/W is 0 (FIG. 14), then the master writes to the slave device. Otherwise, if the data direction bit R/W is 1, the master reads from the slave device (FIG. 15).

Once the slave address and the data direction bit R/W have been sent, the master may continue to read or write.

The communication stops with the STOP condition that also signals that the I²C bus is free.

If the master needs to communicate with other slaves, it may generate a repeated START condition with another slave address without generating a STOP condition.

If the master only writes to the slave device, then the direction of data transfer does not change (FIG. 14); the slave receiver acknowledges each byte.

If the master only needs to read from the slave device, then it simply sends the I²C address with the bit R/W set on read. Subsequently, the master device starts to read the data (FIG. 15).

At the time of the first acknowledge, the master-transmitter becomes the master-receiver and the slave-receiver becomes the slave-transmitter. This first acknowledge A is still generated by the slave. The master generates the following acknowledges. The STOP condition is generated by the master, which sends a not-acknowledge just before the STOP condition.

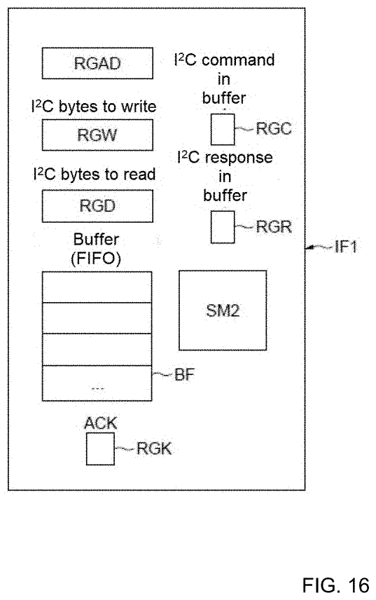

In the example of interface IF1 described here with reference to FIG. 16, the serial controller SM2 is the master device and the sensors CPTi are the slaves.

The interface IF1 integrates: a volatile memory, for example a buffer BF (FIFO), for storing I²C bytes; a plurality of registers (for example: a register RGAD to store the address of the sensor concerned by the command, a register RGW to store the number of I²C bytes to write, a register RGD to store the number of I²C bytes to read, a register RGC (containing one bit) to signal that an I²C command is present in the buffer BF, a register RGR (containing one bit) to signal that an I²C response is present in the buffer BF, a register RGK (containing one bit) to record an acknowledge bit value (this register RGK is reset to read)); and the serial controller SM2 that will elaborate the final module commands CMDM containing the START and STOP conditions and receive the I²C responses coming from the sensor.

The registers RGD, RGW, RGC, RGR, RGK contain configuration data (one or more bits) that makes it possible, for example, to determine the presence or the absence of an operation to be executed, the type of operation (write or read operation) or the status of the operation (terminated, for example) or the result of the operation (successful, for example).

These command registers are read and/or written: by the processing circuit MT, or by the serial controller SM2.

More specifically, the registers RGD, RGW and RGC are written by the processing circuit MT.

For example, if the register RGC contains the value 0, this means that there is no I²C command to be executed by the controller SM2.

If the register RGC contains the value 1, this means that there is an I²C command to be executed by the controller SM2, this command being either a write operation or a read operation.

The type of operation (read or write) is determined by the content of the registers RGD and RGW.

More specifically, if, for example, the value contained in the register RGD is zero and that the value contained in the register RGW is not zero, the operation requested by the reader is a write operation.

If the value contained in the register RGW is zero and that the value contained in the register RGD is not zero, the operation requested by the reader is a read operation.

The register RGW and the register RGD are also read by the controller SM2 in order to know the number of bytes to write or read in the designated slave module.

The register RGC is also read by the controller SM2 to know whether a command must be executed on the bus and is also written by the controller SM2 when the execution of the command has started.

The register RGC is also read by the processing circuit MT to know whether the execution of a requested command is terminated.

The register RGR is written by the controller SM2 to indicate that the read bytes are stored in the buffer BF, and the register RGR is also read by the processing circuit to check whether the I²C read operation is terminated.

The register RGK (initially set for example to 1) is written by the controller SM2 after receiving acknowledge bits, read by the processing circuit MT to check whether the read or write operation is successful, and reset to 1 by the processing circuit MT.

From this configuration data, the data contained in the registers RGD and RGW is data defining whether a command is a write operation or a read operation in the designated slave module.

The data contained in the register RGC is data that defines the presence or the absence of an operation to execute on the bus.

The data contained in the register RGC is also a data that indicates whether the execution of a write operation is terminated and the data contained in the register RGR is data indicating whether the execution of a read operation is terminated.

The data contained in the register RGK is data that indicates whether a read or write operation has been successful.

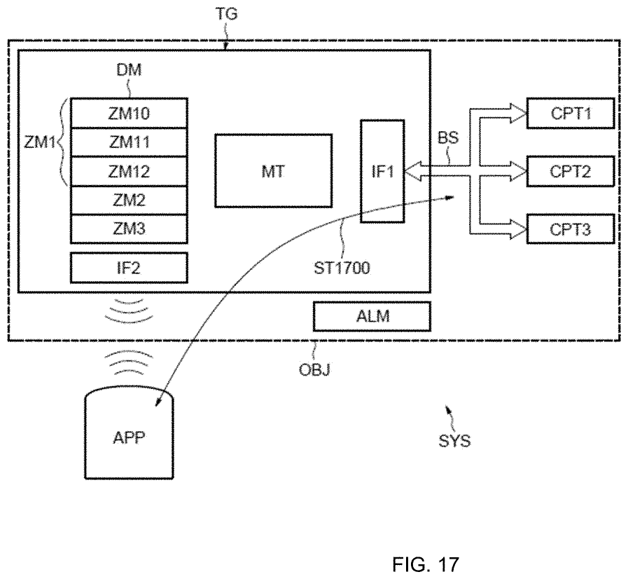

As schematically illustrated in FIG. 17, the system may have a second mode of operation wherein the apparatus and the transponder are configured to make a direct communication ST1700 possible between the apparatus APP and at least one module CPTi via a direct communication between the first interface IF1 and the second interface IF2 of the transponder TG.

In other words, in this second mode of operation, the transponder behaves as a single passage (or gateway) between the reader APP and the sensor.

One example of operation of a transponder as gateway has been described in the PCT application filed on 14 May 2020 under the no. PCT/EP2020/063427 (incorporated by reference).

The person skilled in the art may refer to this PCT application.

In this PCT application the apparatus and the interface IF1 are masters on the bus BS.

The two modes of operation may be selected, for example, by a selection signal emitted by the apparatus.

Here again this selection signal may be emitted during the receipt of a RF command of the type of that illustrated in FIG. 7A, designating at an address of the third memory area ZM3 a so-called selection register.

The transponder, with these two possible modes of operation, then becomes compatible with applications wherein it is preferable to opt for the second mode of operation, at least temporarily.

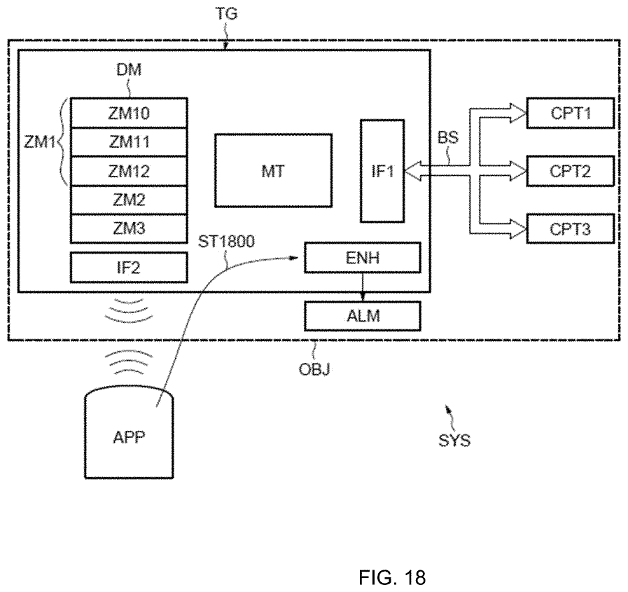

The power supply ALM may, as schematically illustrated in FIG. 18, be rechargeable and the transponder may then include an energy harvesting circuit ENH, of conventional structure and known per se, that can be activated by the apparatus (step ST1800) and configured to recharge the rechargeable power supply.

1. A system, comprising:
a contactless transponder including a non-volatile memory device and an autonomous power supply configured to power the contactless transponder;
an apparatus external to the contactless transponder; and
a module external to the contactless transponder and coupled to the contactless transponder;
wherein the apparatus is configured in a first mode of operation for the system to transmit to the contactless transponder, according to a contactless communication protocol, module command information associated with said module and module data information relating to data to be written to or to be read from said module; and
wherein the contactless transponder is configured in the first mode of operation for the system to store the module command information and module data information in a first area of the non-volatile memory device, and to autonomously communicate, in response to an activation signal, according to a first communication protocol with said module by using said module command information and module data information.

2. The system according to claim 1, wherein the apparatus is configured to deliver to the contactless transponder data to be written to said module by using the contactless communication protocol, and wherein the contactless transponder is configured to store the data in a first sub-area of the first memory area of the non-volatile memory device, and wherein the module command information includes command information to write the data in said module.

3. The system according to claim 2, wherein the module command information includes command information to read data from said module, and wherein the contactless transponder is configured to store the read data in a second sub-area of the first area of the non-volatile memory device, and to communicate this read data to the apparatus by using the contactless communication protocol.

4. The system according to claim 1, wherein said module is coupled to the contactless transponder by a bus supporting the first communication protocol, said first communications protocol comprising a serial communication protocol.

5. The system according to claim 1, wherein the contactless transponder is configured to communicate with a plurality of modules and wherein said module control information includes a module identifier.

6. The system according to claim 1:
wherein the contactless transponder comprises a first interface configured to communicate with said module according to the first communication protocol, and a second interface configured to communicate with the external apparatus according to the contactless communication protocol;
wherein the apparatus is configured to deliver to the second interface initial commands in accordance with the contactless communication protocol and containing said module command information and said module data information;
wherein the second interface of the contactless transponder is configured to extract said module command information and said module data information from the initial commands for delivery to the memory device in view of its storage; and
wherein the contactless transponder comprises a processing circuit configured, in response to the activation signal, to autonomously extract said module command information and said module data information from the memory device and form a module command for the module that is delivered to the first interface, the first interface being configured to elaborate a final module command from the module command in accordance with the first communication protocol for delivery to said module.

7. The system according to claim 16, wherein the apparatus and the contactless transponder, in a second mode of operation, are configured to support a direct communication between the apparatus and said module via a direct communication between the first interface and the second interface of the contactless transponder.

8. The system according to claim 1, wherein the apparatus is configured to deliver the activation signal to the contactless transponder.

9. The system according to claim 1, wherein the autonomous power supply is rechargeable and the contactless transponder includes an energy harvesting circuit that can be activated by the apparatus and configured to recharge the autonomous power supply.

10. The system according to claim 1, wherein said module comprises a sensor.

11. The system according to claim 1, wherein the apparatus comprises a contactless reader.

12. The system according to claim 1, wherein an object incorporates the contactless transponder, the autonomous power supply, and the module.

13. A contactless transponder, comprising:
a non-volatile memory device;
an autonomous power supply configured to power the contactless transponder;
means for communicating with an apparatus external to the contactless transponder;
means for communicating with a module external to the contactless transponder;
wherein the contactless transponder is configured in a first mode of operation to use said means for communicating with the apparatus to receive from the apparatus, according to a contactless communication protocol, module command information associated with said module and module data information relating to data to be written to or to be read from said module;
wherein the contactless transponder is further configured in the first mode of operation to store the module command information and module data information in a first area of the non-volatile memory device, and to use said means for communicating with the module to autonomously communicate, in response to an activation signal, according to a first communication protocol with said module by using said module command information and module data information.

14. The contactless transponder according to claim 13, wherein the contactless transponder is configured to store the data in a first sub-area of the first memory area of the non-volatile memory device, and wherein the module command information includes command information to write the data in said module.

15. The contactless transponder according to claim 14, wherein the module command information includes command information to read data from said module, and wherein the contactless transponder is configured to store the read data in a second sub-area of the first area of the non-volatile memory device, and to use the means for communicating with the apparatus to communicate this read data to the apparatus by using the contactless communication protocol.

16. The contactless transponder according to claim 13, further comprising a bus coupling said module to the contactless transponder, said bus supporting the first communication protocol, said first communications protocol comprising a serial communication protocol.

17. The contactless transponder according to claim 13, wherein the contactless transponder is configured to communicate with a plurality of modules and wherein said module control information includes a module identifier.

18. The contactless transponder according to claim 13:
wherein the means for communicating with the module comprises a first interface configured to communicate with said module according to the first communication protocol; and
wherein the means for communicating with the apparatus comprises a second interface configured to communicate with the external apparatus according to the contactless communication protocol;
said second interface configured to receive initial commands in accordance with the contactless communication protocol and containing said module command information and said module data information;
said second interface further configured to extract said module command information and said module data information from the initial commands for delivery to the memory device in view of its storage; and
further comprising a processing circuit configured, in response to the activation signal, to autonomously extract said module command information and said module data information from the memory device and form a module command for the module that is delivered to the first interface, the first interface being configured to elaborate a final module command from the module command in accordance with the first communication protocol for delivery to said module.

19. The contactless transponder according to claim 18, wherein the contactless transponder further supports, in a second mode of operation, a direct communication between the first interface and the second interface of the contactless transponder.

20. The contactless transponder according to claim 13, wherein the activation signal is received from the apparatus.

21. The contactless transponder according to claim 13, wherein the autonomous power supply is rechargeable and further comprising an energy harvesting circuit that is activated to recharge the autonomous power supply.

22. A method of communication between a contactless transponder, an apparatus external to the contactless transponder and a module external to the contactless transponder and coupled to the contactless transponder, comprising:
in a first mode of operation:
transmitting by the apparatus to the contactless transponder, according to a contactless communication protocol, module command information associated with said module and module data information relating to data to be written to or to be read from said module;
storing by the contactless transponder of the module command information and module data information in a first area of a non-volatile memory device; and
in response to an activation signal, autonomously communicating, according to a first communication protocol, with said module by using the module command information and module data information.

23. The method according to claim 22, wherein transmitting by the apparatus comprises delivering to the contactless transponder data to be written in said module by using the contactless communication protocol, wherein storing by the contactless transponder comprises storing the data in a first sub-area of the first memory area of the non-volatile memory device, and wherein the module command information includes command information to write the data in said module.

24. The method according to claim 22, wherein the module command information includes command information to read data from said module, the method further comprising:
storing by the contactless transponder of the read data in a second sub-area of the first area of the non-volatile memory device; and
communicating the read data to the external apparatus by using the contactless communication protocol.

25. The method according to claim 22, wherein each item of module control information is associated with a module and includes a module identifier.

26. The method according to claim 22, further comprising:
in a second mode of operation, communicating directly between the apparatus and said module by using the contactless transponder as a gateway for transferring commands from the apparatus to said module and as a gateway for transferring read data from said module to the apparatus.

27. The method according to claim 22, further comprising delivering the activation signal from the apparatus to the contactless transponder.

28. The method according to claim 22, wherein the apparatus comprises a contactless reader and module comprises a sensor.
